(19) United States
(12) Patent Application Publication
(10) Pub. No.: US 2025/0182747 A1
(43) Pub. Date: Jun. 5, 2025

(54) USING TEXT CORRECTIONS TO IMPROVE THE ACCURACY OF AN LLM

(71) Applicant: Google LLC, Mountain View, CA (US)

(72) Inventors: Dragan Zivkovic, Sunnyvale, CA (US); Xiaowen Feng, Mountain View, CA (US)

(73) Assignee: Google LLC, Mountain View, CA (US)

(21) Appl. No.: 18/939,827

(22) Filed: Nov. 7, 2024

Related U.S. Application Data
(60) Provisional application No. 63/606,589, filed on Dec. 5, 2023.

(51) Int. Cl. G10L 15/08; G10L 15/01

(52) U.S. Cl. CPC G10L 15/083; G10L 15/01

(57) ABSTRACT

A method includes receiving a task prompt representative of a user input from a user and identifying, based on the task prompt, a context of the user input. The task prompt specifies a task for a large language model (LLM) to perform responsive to the user input. The method also includes determining, based on the context of the user input, a user correction prompt including one or more user changes made by the user to one or more prior outputs of the LLM. The method also includes providing, as input to the LLM, the task prompt conditioned on the user correction prompt to cause the LLM to generate a personalized response to the user input and providing the personalized response to the user input for output from a user device associated with the user.

### CROSS-REFERENCE TO RELATED APPLICATIONS

This U.S. Patent Application claims priority under 35 U.S.C. § 119(e) to U.S. Provisional Application 63/606,589, filed on Dec. 5, 2023. The disclosure of this prior application is considered part of the disclosure of this application and is hereby incorporated by reference in its entirety.

### TECHNICAL FIELD

This disclosure relates to using text corrections to improve the accuracy of a large language model (LLM).

### BACKGROUND

Large language models (LLMs) are increasingly used to perform complex language-based tasks, such as speech recognition or transcription, or text recognition, summarization, translation, prediction, understanding, processing or generation.

### SUMMARY

One aspect of the disclosure provides a computer-implemented method that when executed on data processing hardware causes the data processing hardware to perform operations that include receiving a task prompt representative of a user input from a user. The task prompt specifies a task for a large language model (LLM) to perform responsive to the user input. The operations also include identifying, based on the task prompt, a context of the user input and determining, based on the context of the user input, a user correction prompt including one or more user changes made by the user to one or more prior outputs of the LLM. The operations also include providing, as input to the LLM, the task prompt conditioned on the user correction prompt to cause the LLM to generate a personalized response to the user input and providing the personalized response to the user input for output from a user device associated with the user.

Implementations of the disclosure may include one or more of the following optional features. In some implementations, identifying the context of the user input includes identifying a task type for the task specified by the task prompt for the LLM to perform, while determining the user correction prompt includes selecting the one or more user changes made by the user to prior outputs of the LLM when performing tasks associated with the task type. In these implementations, the task type includes at least one of a speech recognition task, a text prediction task, or a text generation task.

In some examples, identifying the context of the user input includes identifying a topic associated with the user input, while determining the user correction prompt includes selecting the one or more user changes made by the user to prior outputs of the LLM responsive to corresponding prior user inputs from the user associated with the topic.

In some additional implementations, the user input includes audio data characterizing an utterance spoken by the user and the task prompt representative of the user input includes a speech recognition representation of the utterance. Here, the one or more user changes may include corrections made by the user to prior transcriptions generated by the LLM. Additionally, the speech recognition representation may optionally include at least one of: an audio encoding of the audio data characterizing the utterance, the audio encoding output by an audio encoder of a speech recognition model; a list of speech recognition hypotheses for the utterance output by the speech recognition model; or a transcription of the utterance output by the speech recognition model. The user correction prompt may configured to guide the LLM to generate the personalized response while parameters of the LLM are held fixed.

In some examples, the operations also include applying a corresponding weight to each of the one or more user changes and determining the user correction prompt based on the corresponding weight applied to each of the one or more user changes. Here, applying the corresponding weight to each of the one or more user changes may include, for each particular user change of the one or more user changes: determining a number of times that the particular user change was made by the user; and determining the corresponding weight to apply to the particular user change based on the number of times that the particular user change was made by the user. Alternatively, applying the corresponding weight to each of the one or more user changes may optionally include, for each particular user change of the one or more user changes: determining an elapsed time since when the particular user change was last made by the user; and determining the corresponding weight to apply to the particular user change based on the elapsed time since when the particular user change was last made.

In some implementations, the LLM executes on a remote computing system in communication with the data processing hardware via a network and providing the task prompt conditioned on the user correction prompt as input to the LLM includes transmitting, from the data processing hardware to the remote computing system via the network, the task prompt conditioned on the user correction prompt. The remote computing system may not retain the one or more user changes. In other implementations, the LLM executes on the data processing hardware and providing the task prompt conditioned on the user correction prompt as input to the LLM includes processing, using the LLM, the task prompt conditioned on the user correction prompt to generate the personalized response to the user input.

Another aspect of the present disclosure provides a system that includes data processing hardware and memory hardware storing instructions that when executed on the data processing hardware causes the data processing hardware to perform operations that include receiving a task prompt representative of a user input from a user. The task prompt specifies a task for a large language model (LLM) to perform responsive to the user input. The operations also include identifying, based on the task prompt, a context of the user input and determining, based on the context of the user input, a user correction prompt including one or more user changes made by the user to one or more prior outputs of the LLM. The operations also include providing, as input to the LLM, the task prompt conditioned on the user correction prompt to cause the LLM to generate a personalized response to the user input and providing the personalized response to the user input for output from a user device associated with the user.

This aspect of the disclosure may include one or more of the following optional features. In some implementations, identifying the context of the user input includes identifying a task type for the task specified by the task prompt for the LLM to perform, while determining the user correction prompt includes selecting the one or more user changes made by the user to prior outputs of the LLM when performing tasks associated with the task type. In these implementations, the task type includes at least one of a speech recognition task, a text prediction task, or a text generation task.

In some examples, identifying the context of the user input includes identifying a topic associated with the user input, while determining the user correction prompt includes selecting the one or more user changes made by the user to prior outputs of the LLM responsive to corresponding prior user inputs from the user associated with the topic.

In some additional implementations, the user input includes audio data characterizing an utterance spoken by the user and the task prompt representative of the user input includes a speech recognition representation of the utterance. Here, the one or more user changes may include corrections made by the user to prior transcriptions generated by the LLM. Additionally, the speech recognition representation may optionally include at least one of: an audio encoding of the audio data characterizing the utterance, the audio encoding output by an audio encoder of a speech recognition model; a list of speech recognition hypotheses for the utterance output by the speech recognition model; or a transcription of the utterance output by the speech recognition model. The user correction prompt may configured to guide the LLM to generate the personalized response while parameters of the LLM are held fixed.

In some examples, the operations also include applying a corresponding weight to each of the one or more user changes and determining the user correction prompt based on the corresponding weight applied to each of the one or more user changes. Here, applying the corresponding weight to each of the one or more user changes may include, for each particular user change of the one or more user changes: determining a number of times that the particular user change was made by the user; and determining the corresponding weight to apply to the particular user change based on the number of times that the particular user change was made by the user. Alternatively, applying the corresponding weight to each of the one or more user changes may optionally include, for each particular user change of the one or more user changes: determining an elapsed time since when the particular user change was last made by the user; and determining the corresponding weight to apply to the particular user change based on the elapsed time since when the particular user change was last made.

In some implementations, the LLM executes on a remote computing system in communication with the data processing hardware via a network and providing the task prompt conditioned on the user correction prompt as input to the LLM includes transmitting, from the data processing hardware to the remote computing system via the network, the task prompt conditioned on the user correction prompt. The remote computing system may not retain the one or more user changes. In other implementations, the LLM executes on the data processing hardware and providing the task prompt conditioned on the user correction prompt as input to the LLM includes processing, using the LLM, the task prompt conditioned on the user correction prompt to generate the personalized response to the user input.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example environment using a large language model (LLM) for performing tasks.

FIG. 2 is a schematic view of an example prompt module for generating user correction prompts for an LLM.

FIG. 3 is a flow chart of an example arrangement of operations for a method of using text corrections to improve the accuracy of an LLM.

FIG. 4 is a schematic view of an example computing device that may be used to implement the systems and methods described herein.

Like reference symbols in the various drawings indicate like elements.

### DETAILED DESCRIPTION

Large language models (LLMs) are increasingly used to perform complex language-based tasks, such as speech recognition or transcription, text summarization, text-to-text translation, text prediction, natural language understanding, or text generation. Conventional LLMs are trained on a large quantity of global data that includes data pertaining to a large number of users. Accordingly, a conventional LLM is not able to provide personalized responses for a particular user. Moreover, a conventional LLM is not able to learn from a user's past interactions with the LLM and, thus, may repeat past mistakes. Therefore, there is a need for a prompt module that can learn from a user's past interactions with the LLM and prompt the LLM, based on those interactions, to provide personalized responses. Here, the prompt module determines, based on a task prompt representative of a user input from a user, a user correction prompt including one or more user changes made by the user to prior outputs of the LLM, and provides the task prompt conditioned on the user correction prompt to the LLM to cause the LLM to generate a personalized response to the user input.

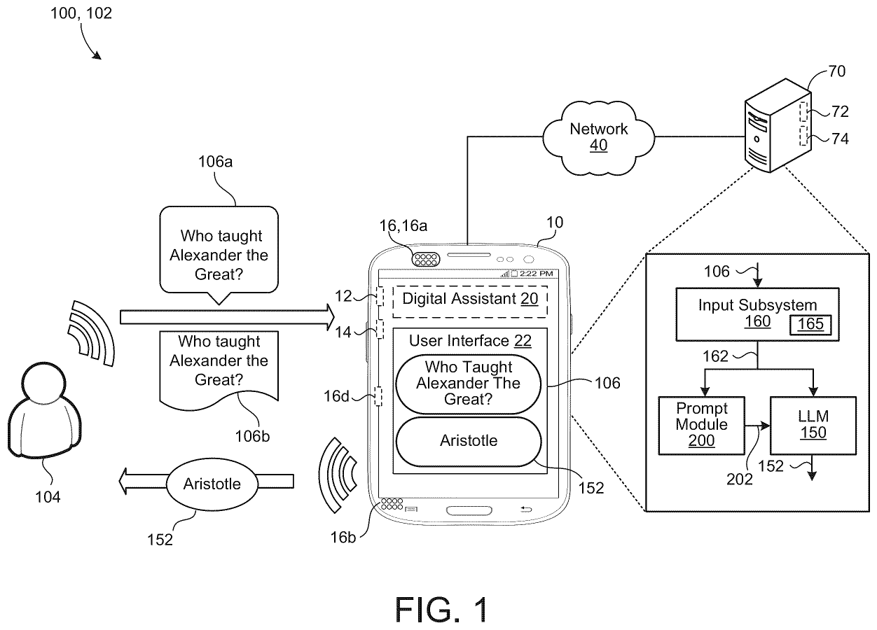

FIG. 1 is a schematic view of an example system 100 that includes an LLM 150 for performing tasks within an environment 102. The system 100 includes a user device 10 interacting with a user 104 to perform tasks using the LLM 150. In some examples, a digital assistant interface 20 (or simply ‘digital assistant’) executes on the user device 10 and the user 104 interacts with the digital assistant 20 by providing user inputs 106 that specify tasks for the LLM 150 to perform. The user 104 may provide user inputs 106 in the form of speech-based user inputs 106a (e.g., spoken utterances) that includes audio data characterizing an utterance spoken by the user and/or text-based user inputs 106b via a physical or virtual keyboard 16d of the user device 10. The task specified by the user input 106 for the LLM 150 to perform may include, without limitation, a query for the LLM to answer a question (question and answering task), a request for the LLM to summarize text or contents of a document, a request to translate content written/spoken in one language into one or more other languages (i.e., a text translation task), a request to analyze sentiment/understanding of text (a text prediction task), facilitate conversation (e.g. via the digital assistant) with the user 104, or generate continuation text that completes a sentence to name a few (i.e., a text generation task). In some examples, the LLM 150 is leveraged as a speech decoder for outputting a speech recognition result of the spoken utterance 106a. In these examples, the LLM 150 may decode audio encodings of the spoken utterance 106a encoded by an audio encoder of a speech recognition system 165 or the LLM 150 may be leveraged as a second pass rescorer to rescore first pass speech recognition results for the utterances 106a that were output by the speech recognition system 165. Accordingly, the LLM 150 may be configured to perform speech recognition as a task or as a sub-task. For instance, the spoken input 106a may include the user speaking a question for the LLM 150 to answer, whereby the LLM 150 may initially output a final transcription for the spoken utterance that conveys the question in text and then process the text as the task prompt 162 to generate the response 152 that answers the question specified by the spoken user input 106a. In this sense, the user 104 may have a conversational dialog with the digital assistant 20 via back-and-forth interactions between the user 104 and the digital assistant 20 conveying responses 152 returned from the LLM 150 to the user 104. Responses (i.e., outputs) 152 generated by the LLM 150 and returned to the user 104 may indicate performance of tasks specified by corresponding user inputs 106. The digital assistant 20 may provide the response 152 as text for presentation in a user interface 22 displayed on a screen 16c of the user device 10 and/or as synthesized speech audibly output by an audio output device (e.g., speaker) 16b of the user device 10. In some examples, the response 152 generated by the LLM 150 is represented by a sequence of text and a text-to-speech (TTS) system (not shown) converts the text into synthesized speech that conveys the response 152. In the example shown, the user 104 provides the user input 106 requesting the LLM 150 to answer the question “Who taught Alexander the Great?” and the LLM 150 answering the question by returning the response 150 of “Aristotle”.

The user device 10 may correspond to any computing device associated with a user 104 and capable of capturing user inputs 106 and providing, in response, textual or audible outputs. Some examples of user devices 10 include, but are not limited to, mobile devices (e.g., mobile phones, tablets, laptops, etc.), computers, wearable devices (e.g., a smart watch, smart glasses, smart goggles, an augmented reality (AR) headset, a virtual reality (VR) headset, etc.), smart appliances, Internet of things (IoT) devices, vehicle infotainment systems, smart displays, smart speakers, etc. The user device 10 includes data processing hardware 12 and memory hardware 14 in communication with the data processing hardware 12 and storing instructions, that when executed by the data processing hardware 12, causes the data processing hardware 12 to perform one or more operations. The user device 10 further includes, or is in communication with, one or more input/output devices 16, 16a-d, such as an audio capture device 16a (e.g., an array of one or more microphones) for capturing and converting spoken user inputs 106a into electrical signals, the audio output device 16b (e.g., a speaker), the screen 16c for presenting visual content, or the keyboard 16d (e.g., a physical or virtual keyboard) for capturing text-based user inputs 106b. Of course, any number and/or type(s) of other input/output devices 16 may be used. The input/output devices 16 may reside on or be in communication with the user device 10. The graphical user interface 22 may execute on the data processing hardware 12 for display on the screen 16d.

The system 102 includes an input subsystem 160 configured to receive the user input 106 and output a task prompt 162 representative of the user input 106. Here, the task prompt 162 specifies a task for the LLM 150 to perform responsive to the user input 106. For a text-based user input 106b, the task prompt 162 may simply include the sequence of words conveyed by the text-based user input 106b such that the text-based user input 106b is provided directly to the LLM 150. However, for a speech-based user input 106a captured by the audio capture device 16a, the input subsystem 160 converts the audio data characterizing the spoken utterance 106a into a digital format for conversion into a speech recognition representation of the spoken utterance 106 by a speech recognition system 165. Here, the task prompt 162 includes the speech recognition representation of the spoken utterance 106a. In some examples, the speech recognition representation output by the speech recognition system 165 includes a transcription of the spoken utterance. Additionally or alternatively, the speech recognition representation may include an audio encoding of the audio data characterizing the utterance 106a output by an audio encoder of the speech recognition system 165 and/or a list of speech recognition hypotheses (e.g., a ranked list of candidate transcriptions) for the utterance 106a output by the speech recognition system 165.

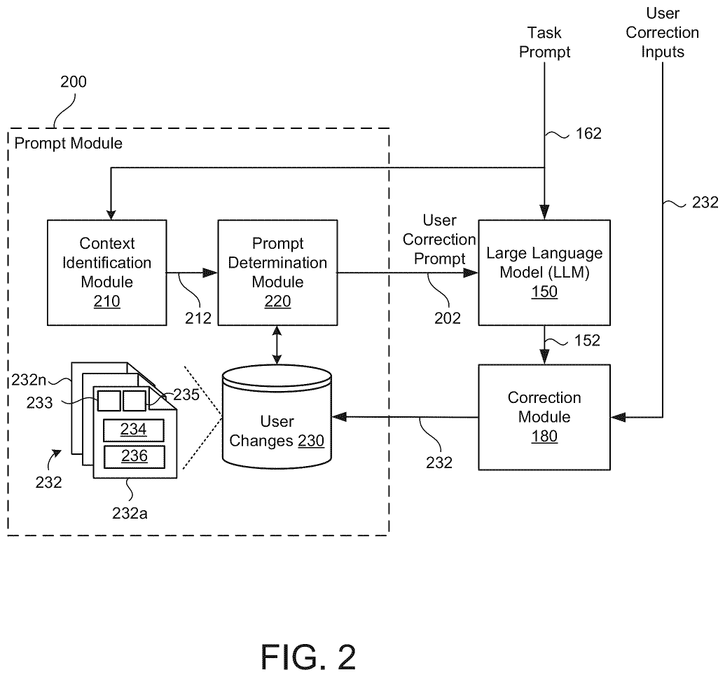

The system 100 also includes a prompt module 200 that is configured to identify, based on the task prompt 162 representative of the user input 106, a context 212 (FIG. 2) of the user input 106, and determine, based on the context 212 of the user input 106, a user correction prompt 202 including one or more user changes made by the user 104 to one or more prior outputs (e.g., responses 152) of the LLM 150. Example user changes include edits, corrections, additions, and/or deletions to the text of one or more prior outputs 152 of the LLM 150. For example, for a spoken user input 106a, the user changes may represent corrections made by the user 104 to a prior transcription generated by the LLM 150. For a user input 106 requesting text generation for a specified topic, the user changes may represent additional material/content added by the user 104 to a response 152 conveying the text generated by the LLM 150 for the specific topic. Thereafter, the LLM 150 receives, as input, the task prompt 162 conditioned on the user correction prompt 202 to cause the LLM 150 to generate a personalized response 152 to the user input 106. Thereafter, the personalized response 152 to the user input 106 may be provided for output from the user device 10 as described above. Here, the task prompt 162 conditioned on the user correction prompt 202 guides the LLM 150 to generate a personalized response 152 that is different from a response that the LLM 150 would otherwise generate for the given task prompt 162 without being conditioned on the user correction prompt 202 or for the same task prompt 162 conditioned on a different user correction prompt 202 for another user. In essence, the personalized response 152 proactively addresses previous user changes made by the user to prior outputs. Notably, the personalized response 152 is generated by the LLM 150 without parameters of the LLM 150 having to be customized, fine-tuned, updated, or trained for the user 104. That is, the user correction prompt 202 is configured to guide the LLM 150 to generate the personalized response 152 while parameters of the LLM 150 are held fixed. Thus, the LLM 150 may correspond to a pre-trained LLM 150 that is not personalized for any specific user, wherein the user correction prompts 202 are leveraged to guide the LLM 150 to output responses 152 that are personalized for a given user 104. Notably, the prompt module 200 may, when there are no applicable user changes, not generate a user correction prompt 202 for conditioning a particular task prompt 162, such that the LLM 150 simply processes only the particular task prompt 162.

Any combination of the LLM 150, the speech recognition system 165, and the prompt module 200 may execute on the user device 10 and/or on a remote computing system 70 (e.g., one or more remote servers of a distributed system executing in a cloud-computing environment) in communication with the user device 10 via a network 40. In some examples, when the LLM 150 executes on the remote computing system 70, the remote computing system 70 does not retain data pertaining to the user correction prompt 202 or other personal data associated with the user. The remote computing system 70 includes data processing hardware 72 and memory hardware 74 in communication with the data processing hardware 72. The memory hardware 74 stores instructions that, when executed by the data processing hardware 72, cause the data processing hardware 72 to perform one or more operations, such as operations disclosed herein.

FIG. 2 is a schematic view of an example prompt module 200 configured to determine, based on a task prompt 162 representative of a particular user input 106 from the user 104, a user correction prompt 202 including one or more user changes 232, 232a-n made by the user 104 to prior outputs 152 of the LLM 150. The system 102 provides, as input to the LLM 150, the task prompt 162 conditioned on the user correction prompt 202 to cause the LLM 150 to generate a personalized response 152 to the particular user input 106.

The prompt module 200 includes a context identification module 210 configured to identify, based on the task prompt 162 representative of the particular user input 106, a context 212 of the particular user input 106. In some examples, the context identification module 210 identifies the context 212 by identifying a task type of the task specified by the task prompt 162 for the LLM 150 to perform. Example task types include, but are not limited to: a speech recognition task to transcribe audio data; a text prediction task, or a text generation task. Additionally or alternatively, the context identification module 210 may identify the context 212 by identifying a topic associated with the particular user input 106. For instance, the topic may be identified by identifying particular keywords in the task prompt representative of the user input 106. Additionally or alternatively, the context identification module 210 may process one or more past turns during a conversational dialog session between the user 104 and the LLM 150 to assist in ascertaining the topic associated with the particular user input 106 input by the user 104 during a current turn in the conversational dialog session.

The prompt module 200 also includes a prompt determination module 220 for determining, based on the context 212 of the particular user input 106, a user correction prompt 202 including one or more user changes 232 made by the user 104 to one or more prior outputs 152 of the LLM 150. In some examples, the prompt determination module 220 determines the user correction prompt 202 by selecting the one or more user changes 232 from a user changes datastore 230 that were made by the user 104 to prior outputs 152 of the LLM 150 when performing tasks having a same task type as that identified by the context identification module 210 for the particular user input 106. For example, for a spoken user input 106a, the user changes 232 may represent corrections made by the user 104 to prior transcriptions 152 of the spoken user input 106a generated by the LLM 150. Additionally or alternatively, the prompt determination module 220 may determine the user correction prompt 202 by selecting the one or more user changes 232 from the user changes datastore 230 made by the user 104 to prior outputs 152 of the LLM 150 for a same topic as that identified by the context identification module 210 for the particular user input 106. Each time a user change 232 is made by the user 104 to a particular output 152 from the LLM 150, a correction module 180 may store the user change 232 in the user changes data store 230 by including original text 234 of at least a portion of the particular output/response 152 paired with corresponding user-corrected text 236 correcting one or more errors in the particular output 152 from the LLM 150.

Moreover, the correction module 180 may append metadata 235 to the corresponding user change 232. The metadata 235 may include a timestamp indicating when the corresponding user change 232 was made by the user. The metadata 235 may additionally indicate one or more of a task type that the LLM 150 performed when generating the particular output 152 corrected by the corresponding user change 232, a topic associated with the particular output 152 corrected by the corresponding user change 232, or a type of change that the corresponding user change 232 includes such as an indication that the user-corrected text 236 changes a spelling for a proper noun in the original text 234 to a different spelling. In some examples, the user-corrected text 236 includes text that the user 104 added to, removed from, or changed in a particular prior output 152 of the LLM 150 responsive to a prior task prompt 162. Notably, a user change 232 may be indicative of a strong preference for the user change 232 and/or the user-provided text 236 given the user 104 took the time to make the user change 232. In some examples, the prompt determination module 220 applies a corresponding weight 233 to each of the one or more user changes 232, and determines the user correction prompt 202 based on the corresponding weights 233 applied to the one or more user changes 232. The value of the corresponding weight 233 applied to each user change 232 may be based on the metadata 235 appended to each user change 232 stored in the user changes datastore 230. For example, the prompt determination module 220 may use the metadata 235 associated with a particular user change 232 to determine a number of times that the particular user change 232 was made by the user 104, and then determine the value of the corresponding weight 233 to apply to the particular user change 232 based on the number of times that the particular user change 232 was made by the user 104. Here, the prompt determination module 220 may process the metadata 235 of the user changes 232 to identify all the user changes 232 that include the type of change associated with the particular change 232. Optionally, the correction module 180 may include, in the metadata 235 for a particular user change 232, a corresponding count of the number of times the particular user change 232 has been made by the user 104. Additionally or alternatively, the prompt determination module 220 may process the metadata 232 to determine an elapsed time since when a particular user change 232 was last made by the user 104, and then determine the value of the corresponding weight 233 to apply to the particular user change 232 based on the elapsed time since when the particular user change 232 was last made. User changes 232 that are more recent and/or that have been made by the user on multiple occasions may be weighted higher than user changes 233 that are less recent and/or less frequent.

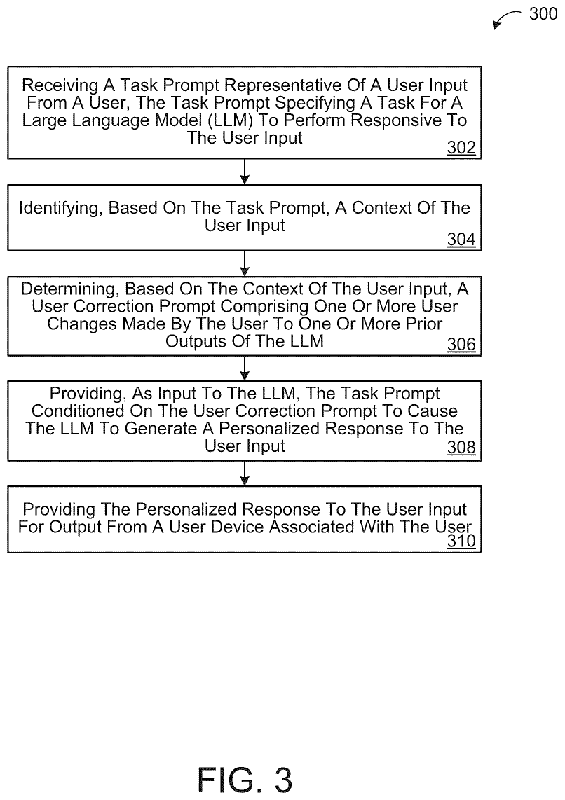

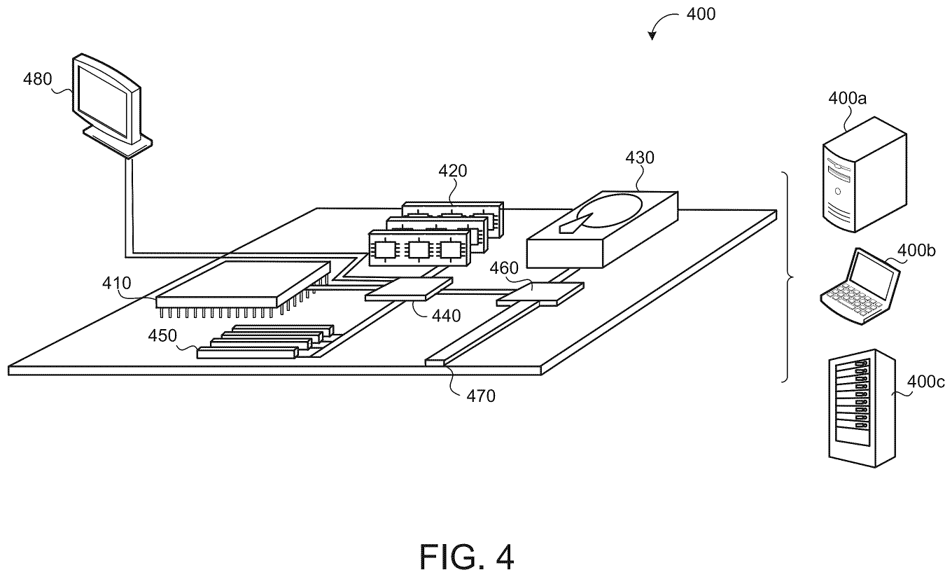

FIG. 3 is a flowchart of an exemplary arrangement of operations for a computer-implemented method 300 of using text corrections to improve the accuracy of the LLM 150. The operations may be performed by data processing hardware 410 (FIG. 4) (e.g., the data processing hardware 12 of the user device 10 or the data processing hardware 72 of the remote computing system 70) based on executing instructions stored on memory hardware 420 (e.g., the memory hardware 14 of the user device 10 or the memory hardware 74 of the remote computing system 70) in communication with the data processing hardware 410.

At operation 302, the method 300 includes receiving a task prompt 162 representative of a user input 106 from a user 104. The task prompt 162 specifies a task for the LLM 150 to perform responsive to the user input 106. At operation 304, the method 300 includes identifying, based on the task prompt 162, a context 212 of the user input 106.

At operation 306, the method 300 includes determining, based on the context 212 of the user input 106, a user correction prompt 202 including one or more user changes 232 made by the user 104 to one or more prior outputs 152 of the LLM 150. At operation 308, the method 300 includes providing, as input to the LLM 105, the task prompt 162 conditioned on the user correction prompt 202 to cause the LLM 150 to generate a personalized response 152 to the user input 106. When the data processing hardware 410 includes the data processing hardware 12 of the user device 10 and the LLM 150 executes on the remote computing system 70, providing the task prompt 162 conditioned on the user correction prompt 202 includes transmitting, from the data processing hardware 410 to the remote computing system 70 via the network 40, the task prompt 12 conditioned on the user correction prompt 202. When the LLM executes on the data processing hardware 410, providing the task prompt 162 conditioned on the user correction prompt 202 includes processing, using the LLM 150, the task prompt conditioned on the user correction prompt 202 to generate the personalized response 152 to the user input 106. At operation 310, the method 300 includes providing the personalized response 152 to the user input 106 for output from a user device 10 associated with the user 104.

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 12 and/or 72, memory 420 (i.e., memory hardware) that can be used to implement the memory hardware 14 and/or 74 or the user changes datastore 230, a storage device 430 (i.e., memory hardware) that can be used to implement the memory hardware 14 and/or 74 or the user changes datastore 230, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a task prompt representative of a user input from a user, the task prompt specifying a task for a large language model (LLM) to perform responsive to the user input;
identifying, based on the task prompt, a context of the user input;
determining, based on the context of the user input, a user correction prompt comprising one or more user changes made by the user to one or more prior outputs of the LLM;
providing, as input to the LLM, the task prompt conditioned on the user correction prompt to cause the LLM to generate a personalized response to the user input; and
providing the personalized response to the user input for output from a user device associated with the user.

2. The computer-implemented method of claim 1, wherein:
identifying the context of the user input comprises identifying a task type for the task specified by the task prompt for the LLM to perform; and
determining the user correction prompt comprises selecting the one or more user changes made by the user to prior outputs of the LLM when performing tasks associated with the task type.

3. The computer-implemented method of claim 2, wherein the task type comprises at least one of a speech recognition task, a text prediction task, or a text generation task.

4. The computer-implemented method of claim 1, wherein:
identifying the context of the user input comprises identifying a topic associated with the user input; and
determining the user correction prompt comprises selecting the one or more user changes made by the user to prior outputs of the LLM responsive to corresponding prior user inputs from the user associated with the topic.

5. The computer-implemented method of claim 1, wherein:
the user input comprises audio data characterizing an utterance spoken by the user; and
the task prompt representative of the user input comprises a speech recognition representation of the utterance.

6. The computer-implemented method of claim 5, wherein the one or more user changes comprise corrections made by the user to prior transcriptions generated by the LLM.

7. The computer-implemented method of claim 5, wherein the speech recognition representation comprises at least one of:
an audio encoding of the audio data characterizing the utterance, the audio encoding output by an audio encoder of a speech recognition model;
a list of speech recognition hypotheses for the utterance output by the speech recognition model; or
a transcription of the utterance output by the speech recognition model.

8. The computer-implemented method of claim 1, wherein the user correction prompt is configured to guide the LLM to generate the personalized response while parameters of the LLM are held fixed.

9. The computer-implemented method of claim 1, wherein the operations further comprise:
applying a corresponding weight to each of the one or more user changes; and
determining the user correction prompt based on the corresponding weight applied to each of the one or more user changes.

10. The computer-implemented method of claim 9, wherein applying the corresponding weight to each of the one or more user changes comprises, for each particular user change of the one or more user changes:
determining a number of times that the particular user change was made by the user; and
determining the corresponding weight to apply to the particular user change based on the number of times that the particular user change was made by the user.

11. The computer-implemented method of claim 9, wherein applying the corresponding weight to each of the one or more user changes comprises, for each particular user change of the one or more user changes:
determining an elapsed time since when the particular user change was last made by the user; and
determining the corresponding weight to apply to the particular user change based on the elapsed time since when the particular user change was last made.

12. The computer-implemented method of claim 1, wherein:
the LLM executes on a remote computing system in communication with the data processing hardware via a network; and
providing the task prompt conditioned on the user correction prompt as input to the LLM comprises transmitting, from the data processing hardware to the remote computing system via the network, the task prompt conditioned on the user correction prompt.

13. The computer-implemented method of claim 12, wherein the remote computing system does not retain the one or more user changes.

14. The computer-implemented method of claim 1, wherein:
the LLM executes on the data processing hardware; and
providing the task prompt conditioned on the user correction prompt as input to the LLM comprises processing, using the LLM, the task prompt conditioned on the user correction prompt to generate the personalized response to the user input.

15. A system comprising:
data processing hardware; and
memory hardware in communication with the data processing hardware, the memory hardware storing instructions that, when executed on the data processing hardware, cause the data processing hardware to perform operations comprising:
receiving a task prompt representative of a user input from a user, the task prompt specifying a task for a large language model (LLM) to perform responsive to the user input;
identifying, based on the task prompt, a context of the user input;
determining, based on the context of the user input, a user correction prompt comprising one or more user changes made by the user to one or more prior outputs of the LLM;
providing, as input to the LLM, the task prompt conditioned on the user correction prompt to cause the LLM to generate a personalized response to the user input; and
providing the personalized response to the user input for output from a user device associated with the user.

16. The system of claim 15, wherein:
identifying the context of the user input comprises identifying a task type for the task specified by the task prompt for the LLM to perform; and
determining the user correction prompt comprises selecting the one or more user changes made by the user to prior outputs of the LLM when performing tasks associated with the task type.

17. The system of claim 16, wherein the task type comprises at least one of a speech recognition task, a text prediction task, or a text generation task.

18. The system of claim 15, wherein:
identifying the context of the user input comprises identifying a topic associated with the user input; and
determining the user correction prompt comprises selecting the one or more user changes made by the user to prior outputs of the LLM responsive to corresponding prior user inputs from the user associated with the topic.

19. The system of claim 15, wherein:
the user input comprises audio data characterizing an utterance spoken by the user; and
the task prompt representative of the user input comprises a speech recognition representation of the utterance.

20. The system of claim 19, wherein the one or more user changes comprise corrections made by the user to prior transcriptions generated by the LLM.

21. The system of claim 19, wherein the speech recognition representation comprises at least one of:
an audio encoding of the audio data characterizing the utterance, the audio encoding output by an audio encoder of a speech recognition model;
a list of speech recognition hypotheses for the utterance output by the speech recognition model; or
a transcription of the utterance output by the speech recognition model.

22. The system of claim 15, wherein the user correction prompt is configured to guide the LLM to generate the personalized response while parameters of the LLM are held fixed.

23. The system of claim 15, wherein the operations further comprise:
applying a corresponding weight to each of the one or more user changes; and
determining the user correction prompt based on the corresponding weight applied to each of the one or more user changes.

24. The system of claim 23, wherein applying the corresponding weight to each of the one or more user changes comprises, for each particular user change of the one or more user changes:
determining a number of times that the particular user change was made by the user; and
determining the corresponding weight to apply to the particular user change based on the number of times that the particular user change was made by the user.

25. The system of claim 23, wherein applying the corresponding weight to each of the one or more user changes comprises, for each particular user change of the one or more user changes:
determining an elapsed time since when the particular user change was last made by the user; and
determining the corresponding weight to apply to the particular user change based on the elapsed time since when the particular user change was last made.

26. The system of claim 15, wherein:
the LLM executes on a remote computing system in communication with the data processing hardware via a network; and
providing the task prompt conditioned on the user correction prompt as input to the LLM comprises transmitting, from the data processing hardware to the remote computing system via the network, the task prompt conditioned on the user correction prompt.

27. The system of claim 26, wherein the remote computing system does not retain the one or more user changes.

28. The system of claim 15, wherein:
the LLM executes on the data processing hardware; and
providing the task prompt conditioned on the user correction prompt as input to the LLM comprises processing, using the LLM, the task prompt conditioned on the user correction prompt to generate the personalized response to the user input.
